(19) United States
(12) Patent Application Publication
(10) Pub. No.: US 2025/0118467 A1
(43) Pub. Date: Apr. 10, 2025

(54) DUST CORE AND METHOD FOR MANUFACTURING DUST CORE

(71) Applicant: Panasonic Intellectual Property Management Co., Ltd., Osaka (JP)

(72) Inventors: Masaaki TAHARA, Osaka (JP); Toru IWABUCHI, Osaka (JP); Hitoshi HORIUCHI, Hyogo (JP)

(73) Assignee: Panasonic Intellectual Property Management Co., Ltd., Osaka (JP)

(21) Appl. No.: 18/836,217

(22) PCT Filed: Dec. 12, 2022
(86) PCT No.: PCT/JP2022/045618

§ 371 Date: Aug. 6, 2024

(30) Foreign Application Priority Data
Feb. 21, 2022 (JP) 2022-024399

(51) Int. Cl. H01F 1/08; H01F 3/08; H01F 41/02

(52) U.S. Cl. CPC H01F 1/083; H01F 3/08; H01F 41/0246

(57) ABSTRACT

A dust core includes a metal magnetic powder and a binding agent that binds particles of the metal magnetic powder. The binding agent includes a silicone resin and an epoxy resin. In an elemental analysis of the dust core based on an image of a cross section of the dust core, when a silicon (Si) element and a carbon (C) element are detected on a weight basis at 15 measurement points between the particles of the metal magnetic powder in the image, a difference between a maximum value and a minimum value of x/(x+y) values at the 15 measurement points is at most 0.243, where x denotes an amount of the Si element detected and y denotes an amount of the C element detected.

### TECHNICAL FIELD

The present disclosure relates to a dust core for use in an inductor and a method for manufacturing the dust core.

### BACKGROUND ART

Various electronic devices include, for example, a DC/DC converter circuit and a step-up/down circuit that adjusts power supply voltage as a drive circuit of the electronic device. An inductor, such as a choke coil and a transformer, is used in these circuits.

Conventionally known inductors include inductors that include a dust core fabricated by pressure-molding a composite magnetic material obtained by mixing a metal magnetic powder and a binding agent since the DC superimposition characteristics are superior, for example. For example, Patent Literature (PTL) 1 discloses a dust core including a metal magnetic powder, first binding agents covering the metal magnetic powder, and a second binding agent that joins the first binding agents.

### CITATION LIST

### Patent Literature

[PTL 1] WO2020/179534

### SUMMARY OF INVENTION

### Technical Problem

In response to increased demand in recent years for downsizing and high performance of electronic devices, dust cores are required to have further enhancement in performance. In view of the above, the present disclosure aims to provide a high-performance dust core and the like.

### Solution to Problem

A dust core according to an aspect of the present disclosure is a dust core including: a metal magnetic powder; and a binding agent that binds particles of the metal magnetic powder, wherein the binding agent includes a silicone resin and an epoxy resin, and in an elemental analysis of the dust core based on an image of a cross section of the dust core, when a silicon (Si) element and a carbon (C) element are detected on a weight basis at 15 measurement points between the particles of the metal magnetic powder in the image, a difference between a maximum value and a minimum value of x/(x+y) values at the 15 measurement points is at most 0.243, where x denotes an amount of the Si element detected and y denotes an amount of the C element detected.

A method for manufacturing a dust core according to an aspect of the present disclosure includes: mixing the metal magnetic powder, the silicone resin, and the epoxy resin to generate a mixture including the metal magnetic powder and the binding agent; and pressure-molding the mixture generated, wherein in the mixing, the epoxy resin to be mixed has a viscosity of at most 1500 mPa·s at 23° C.

A method for manufacturing a dust core according to an aspect of the present disclosure includes: mixing a metal magnetic powder, a silicone resin, and an epoxy resin to generate a mixture; and pressure-molding the mixture generated, wherein in the mixing, the silicone resin to be mixed has a viscosity of at most 500 mPa·s at 25° C. and the epoxy resin to be mixed has a viscosity of at most 1500 mPa·s at 23° C.

### Advantageous Effects of Invention

The present disclosure provides a high-performance dust core and the like.

### BRIEF DESCRIPTION OF DRAWINGS

FIG. 1 is a schematic perspective view showing a configuration of an electrical component that includes a dust core according to an embodiment.

FIG. 2 is a diagram schematically showing a cross section of the dust core according to the embodiment.

FIG. 3 is a flowchart showing a method for manufacturing the dust core according to the embodiment.

FIG. 4 is a diagram showing an image of a cross section of a dust core according to Working Example 1.

FIG. 5 is a diagram showing an image of a cross section of a dust core according to Comparative Example 1.

FIG. 6 is a diagram showing relationships between the weight proportion of a silicone resin and “MaxZ-MinZ” of dust cores according to working examples and comparative examples.

FIG. 7 is a diagram showing relationships between the breakdown voltage and the magnetic permeability of dust cores according to working examples and comparative examples.

FIG. 8 is a diagram showing relationships between the added amount of a coupling agent and the magnetic permeability of dust cores according to working examples, a comparative example, and a reference example.

### DESCRIPTION OF EMBODIMENTS

### (Underlying Knowledge Leading to Conception of an Aspect of the Present Disclosure)

Dust cores are fabricated by pressure-molding a mixture of a metal magnetic powder and a resin material added as a binding agent for binding the particles of the metal magnetic powder in order to insulate the particles of the metal magnetic powder. In order to enhance the magnetic properties of the dust cores, it is important to enhance insulation between the particles of the metal magnetic powder and inhibit leakage current of the metal magnetic powder (and the resulting eddy current loss).

One measure to achieve the above is to strengthen the covering of the metal magnetic powder by the binding agent. For example, PTL 1 enhances the insulation properties and strength of the dust core by fabricating a dust core that includes the first binding agents covering the metal magnetic powder and the second binding agent joining the first binding agents.

Such a two-layer structure of the binding agent as in PTL 1, however, decreases the filling ratio of the metal magnetic powder in the dust core, which in turn increases the distance between the particles of the metal magnetic powder, resulting in a decrease in the magnetic permeability of the dust core. In other words, such a dust core has high insulation properties, but its magnetic permeability is decreased. As a result, the magnetic loss of the dust core cannot be effectively reduced. On the other hand, when the amount of the binding agent is reduced by, for example, making the structure of the binding agent a single-layer structure, the magnetic permeability increases but the insulation properties are degraded. This shows that there is a trade-off relationship between the magnetic permeability and the insulation properties of the dust core.

Use of a relatively soft resin material such as silicone resin as the binding agent also makes the dust core easier to be compressed, and thus the distance between the particles of the metal magnetic powder can be reduced, thereby increasing the magnetic permeability. However, the particles of the metal magnetic powder are more likely to come into contact with each other, resulting in degradation of the insulation properties of the dust core. On the other hand, if a relatively hard resin material such as epoxy resin is used as the binding agent, the particles of the metal magnetic powder are less likely to come into contact with each other, and thus the insulation properties of the dust core are enhanced, but the distance between the particles of the metal magnetic powder increases, thereby decreasing the magnetic permeability.

After intensive studies, the inventors have found that by using a binding agent in which a silicone resin and an epoxy resin are mixed at or above a certain evenness level, it is possible to achieve the magnetic permeability and the insulation properties that are higher than the magnetic permeability and the insulation properties in the trade-off relationship described above. Accordingly, the present disclosure provides a high-performance dust core and the like by achieving both high magnetic permeability and high insulation properties.

Hereinafter, exemplary embodiments will be specifically described with reference to the drawings.

Note that each of the embodiments described below illustrates a specific example of the present disclosure. The numerical values, shapes, materials, constituent elements, the arrangement and connection of the constituent elements, steps, the processing order of the steps, etc. illustrated in the embodiments below are mere examples, and are not intended to limit the present disclosure. Among the constituent elements in the embodiments below, constituent elements not recited in any one of the independent claims will be described as optional constituent elements.

The drawings are represented schematically and are not necessarily precise illustrations. Therefore, the scales, for example, are not necessarily consistent from drawing to drawing. In the drawings, essentially the same constituent elements share the same reference signs, and redundant descriptions will be omitted or simplified.

In the present specification, terms indicating a relationship between elements such as “parallel” and “orthogonal”, terms indicating the shape of elements such as “rectangular” and “rectangular parallelepiped”, and numerical value ranges do not represent their strict meanings only but also include substantially equivalent ranges, e.g., differences of several percent.

### EMBODIMENT

### [Configuration]

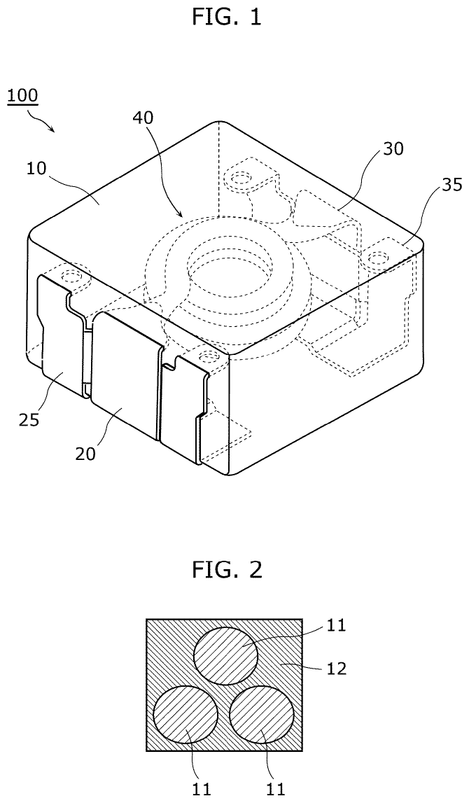

First, an electrical component will be described with reference to FIG. 1 and FIG. 2 as a usage example of a dust core according to an embodiment of the present disclosure.

FIG. 1 is a schematic perspective view showing a configuration of the electrical component that includes the dust core according to the embodiment. FIG. 1 shows the outline of dust core 10, which will be described later, and further shows the inside of dust core 10 in a transparent manner. For example, constituent elements invisible by being embedded in dust core 10, such as coil member 40, are illustrated with broken lines to show that such constituent elements are seen through dust core 10.

As shown in FIG. 1, electrical component 100 includes dust core 10, coil member 40, first terminal member 25, and second terminal member 35.

Electrical component 100 is, for example, an inductor having a rectangular parallelepiped shape, and a rough profile of electrical component 100 is determined by the shape of dust core 10. Note that dust core 10 can be formed into any shape by pressure-molding. That is to say, any shape of electrical component 100 can be achieved by shaping dust core 10 through pressure-molding. Therefore, the shape of the dust core is not limited to a rectangular parallelepiped shape and may be a different shape.

Electrical component 100 is a passive element in which coil member 40 stores, as magnetic energy, electrical energy flowing between first terminal member 25 and second terminal member 35. In the present embodiment, electrical component 100 will be described as one usage example of dust core 10; however, dust core 10 may be simply used as a magnetic material, and the usage example of dust core 10 is not limited to electrical component 100 according to the present embodiment. Dust core 10 may be used in desired applications where the properties of a magnetic material having high magnetic properties (specifically, high magnetic permeability and insulation properties) can be utilized.

Dust core 10 has a substantially quadrangular prism shape having rectangular opposing surfaces on which first terminal member 25 and second terminal member 35 are formed. The respective four sides of the opposing surfaces are connected by the top surface, the bottom surfaces, and two side surfaces of the substantially quadrangular prism. In the present embodiment, the bottom surface and the top surface of dust core 10 each have a rectangular shape with the dimensions of about 14.0 mm×12.5 mm, for example, and the separation distance from the bottom surface to the top surface is about 8.0 mm.

FIG. 2 is a diagram schematically showing a cross section of dust core 10. FIG. 2 is an enlarged view of a portion of a cross section of dust core 10.

As shown in FIG. 2, dust core 10 includes metal magnetic powder 11 and binding agent 12 that binds the particles of metal magnetic powder 11.

For metal magnetic powder 11, a Fe—Si—Al-based, Fe—Si-based, Fe—Si—Cr-based, or Fe—Si—Cr—B-based metal magnetic powder is used, for example. Metal magnetic powder 11 has a high saturation magnetic flux density as compared to magnetic powders such as ferrite, thus being useful for use under high current.

For example, in the case of using an Fe—Si—Al-based metal magnetic powder, the composition elements are: Si with a content of at least 8% by weight and at most 12% by weight; Al with a content of at least 4% by weight and at most 6% by weight; and Fe and inevitable impurities constituting the rest. Here, examples of the inevitable impurities include Mn, Ni, P, S, and C. By setting the contents of the composition elements of metal magnetic powder 11 to the above-mentioned composition ranges, high magnetic permeability and low coercive force can be obtained.

For example, in the case of using an Fe—Si-based metal magnetic powder, the composition elements are: Si with a content of at least 1% by weight and at most 8% by weight; and Fe and inevitable impurities constituting the rest. Note that the inevitable impurities are the same as those described above.

For example, in the case of using an Fe—Si—Cr-based metal magnetic powder, the composition elements are: Si with a content of at least 1% by weight and at most 8% by weight; Cr with a content of at least 2% by weight and at most 8% by weight; and Fe and inevitable impurities constituting the rest. Note that the inevitable impurities are the same as those described above.

For example, in the case of using an Fe—Si—Cr—B-based metal magnetic powder, the composition elements are: Si with a content of at least 1% by weight and at most 8% by weight; Cr with a content of at least 2% by weight and at most 8% by weight; B with a content of at least 1% by weight and at most 8% by weight; and Fe and inevitable impurities constituting the rest. Note that the inevitable impurities are the same as those described above.

Si, which is a composition element of metal magnetic powder 11 mentioned above, has a role to impart the effect of reducing magnetic anisotropy and a magnetostriction constant, increasing electrical resistance, and reducing eddy current loss. By setting the content of Si in the composition elements to at least 1% by weight, it is possible to achieve the effect of improving soft magnetic properties, and by setting the content of Si to at most 8% by weight, it is possible to inhibit a decrease in saturation magnetization, thereby inhibiting degradation of DC superimposition characteristics.

With metal magnetic powder 11 containing Cr, it is possible to impart the effect of enhancing weatherability. By setting the content of Cr in the composition elements to at least 2% by weight, it is possible to obtain the effect of improving weatherability, and by setting the content of Cr to at most 8% by weight, it is possible to inhibit degradation of soft magnetic properties.

The median diameter D50 of metal magnetic powder 11 is, for example, at least 5.0 μm and at most 35 μm. To relax electric field concentration between the particles, the median diameter D50 of metal magnetic powder 11 is reduced, thereby ensuring insulation properties. Also, by setting the median diameter D50 as above, it is possible to ensure a high filling rate and high handling. Further, by setting the median diameter D50 of metal magnetic powder 11 to at most 35 μm, it is possible to reduce core loss, particularly, eddy current loss, in a high frequency region. Note that to determine the median diameter D50 of metal magnetic powder 11, the particles of metal magnetic powder 11 are counted, starting from the particle having the smallest diameter to the particle having the largest diameter measured using a particle size distribution meter with a laser diffraction scattering method. The median diameter D50 is the particle diameter at which the integrated value of the count reaches 50% of the whole.

Binding agent 12 is provided to cover the periphery of metal magnetic powder 11. Binding agent 12 is located between the particles of metal magnetic powder 11. Binding agent 12 is a resin material having insulation properties. Binding agent 12 includes a silicone resin and an epoxy resin. The silicone resin and the epoxy resin have thermosetting properties, for example. Although binding agent 12 includes a silicone resin and an epoxy resin, binding agent 12 may include other resin materials, for example. Examples of other resin materials include a phenol resin and a polyimide resin.

In the elemental analysis of dust core 10 based on an image of a cross section of dust core 10, the variation in the ratio of the amount of the silicon (Si) element detected and the amount of the carbon (C) element detected at measurement points between the particles of metal magnetic powder 11 where binding agent 12 is present, is a predetermined value or less.

Specifically, the Si element and the C element are detected on a weight basis at 15 measurement points between the particles of metal magnetic powder 11 in the image of the cross section of dust core 10. The difference between the maximum value and the minimum value of x/(x+y) values at the respective measurement points is at most 0.243, where x denotes the amount of the Si element detected and y denotes the amount of the C element detected. Since the Si element is a component mainly contained in silicone resin, x/(x+y) can be regarded as a value corresponding to the proportion of the silicone resin at the measurement points where binding agent 12 is present. The difference between the maximum value and the minimum value of x/(x+y) values at the respective measurement points is 0 or greater.

The image of the cross section of dust core 10 is, for example, a scanning electron microscope (SEM) image. The elements are detected at each measurement point using, for example, an energy dispersive X-ray (EDX) spectrometer. For example, using scanning electron microscopy-energy dispersive X-ray spectroscopy (SEM-EDX), the amount of each element detected is calculated from the peak intensity corresponding to the element in the EDX spectrum obtained at each measurement point.

To form a cross section of dust core 10, a cross-section forming method in general SEM image observation is used. For example, dust core 10 is embedded using resin or the like and cut, and is then subjected to ion milling to obtain a cross section of dust core 10 for observation.

An image of a region of at least 25 μm×25 μm and at most 50 μm×50 μm, for example, is used as the image of a cross section for detecting the elements at each measurement point. The magnification of the cross-section image is, for example, at least 1000 times and at most 5000 times. Fifteen measurement points are selected to include locations between the particles of metal magnetic powder 11 of different combinations. The distance between the measurement points is, for example, at least 1 μm.

Since binding agent 12 includes a silicone resin and an epoxy resin, the relatively soft silicone resin reduces the distance between the particles of metal magnetic powder 11, enabling an increase in the filling rate of metal magnetic powder 11. Even when the distance between the particles of metal magnetic powder 11 is reduced and the filling ratio is thereby increased, the relatively hard epoxy resin can ensure insulation between the particles of metal magnetic powder 11. However, when the silicone resin is unevenly distributed in binding agent 12, the particles of metal magnetic powder 11 easily contact each other at the unevenly distributed locations, and the insulation cannot be effectively enhanced. In the present embodiment, since the difference between the maximum value and the minimum value of x/(x+y) values is at most 0.243, the variation in the weight proportion of the Si element at the measurement points is small, and the silicone resin is not unevenly distributed in binding agent 12 but is relatively evenly present. It is thus possible to inhibit contact between the particles of metal magnetic powder 11 that happens when the silicone resin is unevenly distributed, and achieve both high insulation properties and a high filling ratio (i.e., magnetic permeability). As a result, the magnetic properties of dust core 10 can be improved. For example, the high insulation properties reduce eddy current loss, and the high magnetic permeability can reduce magnetic loss of dust core 10. In binding agent 12, the silicone resin and the epoxy resin may be compatible with each other.

In binding agent 12, the weight of the silicone resin is, for example, at least 10% and at most 98% of the sum of the weights of the silicone resin and the epoxy resin. With this, the magnetic properties of dust core 10 can be improved more effectively.

The weight of binding agent 12 is, for example, at least 1% and at most 10% of the weight of metal magnetic powder 11.

The silicone resin contains, for example, a hydrocarbon group in the side chain. Examples of the hydrocarbon group include a methyl group and a phenyl group.

Examples of the epoxy resin include bisphenol A epoxy resin, bisphenol F epoxy resin, glycidyl ester epoxy resin, and biphenyl epoxy resin. The epoxy resin is cured by a common curing agent for epoxy resins.

Although not shown in FIG. 2, dust core 10 may further include a coupling agent. The coupling agent is present at least in binding agent 12 or between metal magnetic powder 11 and binding agent 12, for example. For example, a coupling agent having a functional group that bonds to an organic material and a functional group that bonds to an inorganic material is used. Examples of the coupling agent include a titanate-based coupling agent, a mercapto-based coupling agent, and an amino-based coupling agent.

Among these, dust core 10 includes, for example, a titanate-based coupling agent. With this, the magnetic properties of dust core 10 can be improved more effectively.

The weight of the titanate-based coupling agent is, for example, at least 0.05% and at most 2% and may be at least 0.3% and at most 1% of the weight of metal magnetic powder 11.

Although not shown in FIG. 2, dust core 10 may further include insulating powder. Insulating powder is a substance that acts as an electrical insulating material. The insulating powder generally has high heat resistance and, by being used as an electrical insulating material, ensures insulation between the particles of metal magnetic powder 11. Examples of the insulating powder include inorganic particles such as talc.

Continuing to refer to FIG. 1, coil member 40, first terminal member 25, and second terminal member 35 will be described.

Coil member 40 has a conducting wire, which is a long conductor covered by an insulating film, wound around it (a wound portion), and the two ends of the conducting wire are connected to first terminal member 25 and second terminal member 35 (lead portions 20 and 30). In the present embodiment, a round conducting wire having a cross-sectional diameter of about 0.65 mm is used as the conductor. There is no particular limitation on the thickness and shape of the conducting wire. As long as the conducting wire is thick enough to allow winding processing etc., a flat rectangular conducting wire having a rectangular cross section, a round conducting wire, and so on can be selected and used as appropriate. The wound portion is embedded in the vicinity of the center of dust core 10. At lead portions 20 and 30, each of the two ends of the conducting wire extends continuously from the wound portion to a corresponding one of the opposing surfaces and protrudes outward from dust core 10. Here, part of each lead portion is extended to form a flat shape and is bent along the corresponding one of the opposing surfaces and the bottom surface. At the extended part, the insulating film cover is removed to allow electrical connection to the outside.

First terminal member 25 and second terminal member 35 are conductor plates made of, for example, phosphor bronze or a copper material. Each of first terminal member 25 and second terminal member 35 has a recess in the vicinity of its center along a corresponding one of the opposing surfaces and is recessed into dust core 10. Lead portions 20 and 30 are provided outside the recesses. Lead portion 20 and first terminal member 25 are electrically connected. Lead portion 30 and second terminal member 35 are electrically connected. Lead portions 20 and 30 are connected to first terminal member 25 and second terminal member 35, respectively, by resistance welding or the like. First terminal member 25 and second terminal member 35 are bent to be inserted into the inside of dust core 10, and are fixed to dust core 10 with the bent portions inserted into dust core 10.

First terminal member 25 and second terminal member 35, together with lead portions 20 and 30, are bent along the bottom surface of dust core 10. With this, lead portions 20 and 30 are partially located at the bottom side of electrical component 100 while being held by first terminal member 25 and second terminal member 35. That is to say, lead portions 20 and 30 can be directly connected to the land (not illustrated) of a mounting board or the like on which electrical component 100 is mounted.

Note that first terminal member 25 and second terminal member 35 are not essential constituent elements. First terminal member 25 and second terminal member 35 need not be included if lead portions 20 and 30 are strong enough to maintain their shape by themselves.

As described above, dust core 10 according to the present embodiment includes metal magnetic powder 11 and binding agent 12 that binds the particles of metal magnetic powder 11. Binding agent 12 includes a silicone resin and an epoxy resin. In an elemental analysis of dust core 10 based on an image of a cross section of dust core 10, when the silicon (Si) element and the carbon (C) element are detected on a weight basis at 15 measurement points between the particles of metal magnetic powder 11 in the image, the difference between the maximum value and the minimum value of x/(x+y) values at the 15 measurement points is at most 0.243, where x denotes an amount of the Si element detected and y denotes an amount of the C element detected.

According to this configuration, since binding agent 12 includes a silicone resin and an epoxy resin, the relatively soft silicone resin reduces the distance between the particles of metal magnetic powder 11, enabling an increase in the filling rate of metal magnetic powder 11. Even when the distance between the particles of metal magnetic powder 11 is reduced and the filling ratio is thereby increased, the relatively hard epoxy resin can ensure insulation between the particles of metal magnetic powder 11. In addition, since the difference between the above-mentioned maximum value and minimum value is at most 0.243, the variation in the weight proportion of the Si element at the measurement points in binding agent 12 is small, and the silicone resin is not unevenly distributed in binding agent 12 but is relatively evenly present. Thus, there are less locations where the silicone resin is unevenly distributed and the particles of metal magnetic powder 11 easily come into contact with each other, thereby achieving both high insulation properties and a high filling ratio (i.e., magnetic permeability). As a result, the magnetic properties of dust core 10 can be improved. For example, the high insulation properties reduce eddy current loss, and the high magnetic permeability can reduce magnetic loss of dust core 10. As a result, high-performance dust core 10 can be provided.

### [Manufacturing Method]

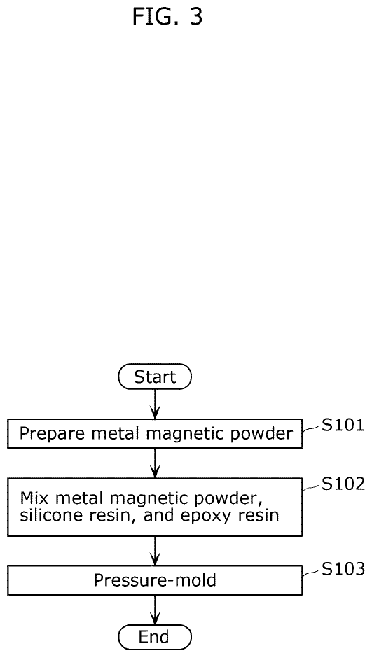

Next, a method for manufacturing above-described dust core 10 will be described with reference to FIG. 3. Note that the method for manufacturing dust core 10 is not limited to the example described below.

FIG. 3 is a flowchart showing the method for manufacturing the dust core according to the embodiment.

To manufacture dust core 10 according to the present embodiment, first, metal magnetic powder 11 including predetermined composition elements is prepared (step S101).

Next, metal magnetic powder 11, a silicone resin, and an epoxy resin are mixed to generate a mixture including metal magnetic powder 11 and binding agent 12 (step S102). Step S102 is an example of the mixing. In step S102, a coupling agent such as a titanate-based coupling agent may be further added and mixed. That is to say, in step S102, a titanate-based coupling agent may be further included in addition to metal magnetic powder 11 and binding agent 12 to generate a mixture.

The silicone resin to be mixed in step S102 is used in a pre-dissolved state, that is, the silicone resin is dissolved in advance in a solvent that dissolves silicone resin, such as isopropyl alcohol or acetone. If the silicone resin to be mixed is a modified silicone resin, it is in an uncross-linked (uncured) state, and the epoxy resin to be mixed is in an uncross-linked (uncured) state and contains a curing agent. The epoxy resin to be mixed may be used in a pre-dissolved state, that is, the epoxy resin may be dissolved in advance in a solvent that dissolves the epoxy resin.

The epoxy resin to be mixed in step S102 has a viscosity of, for example, at most 1500 mPa·s at 23° C. In the present embodiment, the viscosity of the epoxy resin to be mixed is the viscosity of the epoxy resin in a state of containing a curing agent. The viscosity of the epoxy resin can be adjusted by the molecular weight in the uncured state, for example. For example, if an epoxy resin can be selected from among commercially-available epoxy resins, an epoxy resin having a desired viscosity is selected. As described, since an epoxy resin having relatively low viscosity is used for mixing, the mixability of the silicone resin and the epoxy resin is improved and the silicone resin is less likely to be unevenly distributed. In particular, since the viscosity of the epoxy resin has a great effect on the magnetic properties of dust core 10 manufactured, lowering the viscosity of the epoxy resin can effectively improve the magnetic properties of dust core 10. The epoxy resin to be mixed may have a viscosity of at most 1000 mPa·s or at most 500 mPa·s at 23° C. The lower limit of the viscosity, at 23° C., of the epoxy resin to be mixed is not particularly limited as long as it is preparable. The epoxy resin to be mixed has a viscosity of, for example, at least 100 mPa·s at 23° C.

The silicone resin to be mixed in step S102 has a viscosity of, for example, at most 500 mPa·s at 25° C. In the present embodiment, the viscosity of the silicone resin to be mixed is the viscosity of the silicone resin in a state of containing a solvent. The viscosity of the silicone resin can be adjusted, for example, by the molecular weight and the amount of solvent. For example, if a silicone resin can be selected from among commercially-available silicone resins, a silicone resin having a desired viscosity is selected. As described, since a silicone resin having relatively low viscosity is used for mixing, the mixability of the silicone resin and the epoxy resin is improved and the silicone resin is less likely to be unevenly distributed. The lower limit of the viscosity, at 25° C., of the silicone resin to be mixed is not particularly limited as long as it is preparable. The silicone resin to be mixed has a viscosity of, for example, at least 100 mPa·s at 25° C.

To mix the materials constituting the mixture, for example, metal magnetic powder 11, the silicone resin, and the epoxy resin are placed in a mixer or the like and mixed at the same time. The materials constituting the mixture are mixed using, for example, a mortar, mixer, ball mill, V-type mixer, or cross-rotary mixer.

Note that, to mix the materials constituting the mixture, some of the materials may be mixed first, and then the remaining materials may be added and mixed. For example, the silicone resin and the epoxy resin may be mixed first, and then metal magnetic powder 11 may be added and further mixed.

By mixing metal magnetic powder 11, the silicone resin, and the epoxy resin at the same time, or by mixing the silicone resin and the epoxy resin first, the silicone resin and the epoxy resin are mixed before the silicone resin or the epoxy resin forms a coating structure on the surface of metal magnetic powder 11, thus making it easier for the silicone resin to disperse evenly.

If dust core 10 includes insulating powder, a mixture further including the insulating powder may be generated in step S102. In that case, for example, metal magnetic powder 11 and the insulating powder are mixed first, and then the other materials, such as materials used as the binding agent, are added and further mixed.

The mixture mixed as described above is heated at a temperature of at least 65° C. and at most 150° C. to evaporate the solvent and is then crushed to obtain a mixture (a composite magnetic material) having favorable moldability. Furthermore, the composite magnetic material may be classified to obtain a mixture whose particle size is within a predetermined size range. This can further improve the moldability.

The mixture obtained in the manner described above is put into a mold and pressure-molded into a desired shape to obtain dust core 10 (step S103). Step S103 is an example of the pressure-molding. In step S103, the pressure-molding is performed under a pressure in a range of at least 3 tons/cm² and at most 7 tons/cm², for example. Dust core 10 which has been pressure-molded is subjected to curing processing by heating, for example. The condition for the curing processing is set according to the types of the silicone resin and the epoxy resin used.

With these steps S101 to S103, dust core 10 is fabricated. Fabricated dust core 10 is used as part of electrical component 100 having a coil embedded therein. The mixture may be pressure-molded together with coil member 40.

As described above, in the method for manufacturing dust core 10, a mixture including metal magnetic powder 11 and binding agent 12 is generated using, for example, a silicone resin having a viscosity of at most 500 mPa·s at 25° C. and an epoxy resin having a viscosity of at most 1500 mPa·s at 23° C. In such a mixture, the silicone resin and the epoxy resin are easier to be mixed evenly because the silicone resin and the epoxy resin have low viscosity. As a result, in dust core 10 obtained by pressure-molding the mixture, the silicone resin is not unevenly distributed in binding agent 12 but is relatively evenly present. Therefore, although the silicone resin reduces the distance between the particles of metal magnetic powder 11, contact between the particles of metal magnetic powder 11 is inhibited since the epoxy resin is present. Consequently, dust core 10 manufactured can have both high insulation properties and high magnetic permeability. With such a method for manufacturing dust core 10, it is possible to provide high-performance dust core 10 with its magnetic properties improved.

### Working Examples and Comparative Examples

The following describes working examples and comparative examples of the dust core based on the above embodiment. Dust cores according to the working examples and the comparative examples were fabricated and the fabricated dust cores were analyzed and subjected to property evaluation as described below.

### [Fabrication of Dust Cores]

First, fabrication of the dust cores according to the working examples and the comparative examples will be described. In the working examples and the comparative examples, mixtures of the metal magnetic powder, the binding agent, and, if necessary, the coupling agent were prepared, and the prepared mixtures were pressure-molded to fabricate dust cores.

In the working examples and the comparative examples, an Fe—Si—Cr-based metal magnetic powder was used as the metal magnetic powder. The median diameter D50 of the metal magnetic powder was 8.8 μm.

The silicone resin and the epoxy resin having the viscosities shown in Tables 1, 4, and 5 described later were used as the binding agent. The mixtures prepared are mixtures in which the silicone resin and the epoxy resin were added in the amounts (parts by weight) shown in Tables 1, 4, and 5 with respect to 100 parts by weight of the metal magnetic powder. The proportion of the silicone resin shown in Tables 1, 4, and 5 is the weight proportion of the silicone resin relative to the sum of the weights of the silicone resin and the epoxy resin.

A modified silicone resin having methyl and phenyl groups on the side chain and dissolved in a solvent (isopropyl alcohol) in advance (at a concentration of 50%) was used as the silicone resin. A bisphenol A epoxy resin in a state of including a curing agent was used as the epoxy resin. Note that the added amount of the silicone resin shown in Tables 1, 4, and 5 is the added amount by weight excluding the solvent.

The viscosity of the silicone resin shown in Tables 1, 4, and 5 is the viscosity at 25° C. in a state of including the solvent. The viscosity of the epoxy resin shown in Tables 1, 4, and 5 is the viscosity at 23° C. in a state of including the curing agent.

The mixtures in the case of using a coupling agent are mixtures in which the coupling agent of the types shown in Table 5 was added in the amount (parts by weight) shown in Table 5 with respect to 100 parts by weight of the metal magnetic powder.

These materials were used to make mixtures of the metal magnetic powder, the binding agent, and, if necessary, the coupling agent. A mortar was used to mix the materials.

The prepared mixtures were pressure-molded under a pressure of 4 tons/cm² at room temperature to fabricate ring cores each having an outer diameter of 14.4 mm, an inner diameter of 10.3 mm, and a thickness of 4.4 mm for evaluation of magnetic permeability. Furthermore, the ring cores were dried at 150° C. for 2 hours to cure the binding agent, thereby fabricating ring-shaped dust cores.

Also, the prepared mixtures were pressure-molded under a pressure of 4 tons/cm² at room temperature to fabricate plate-shaped compacts each having a length of 12 mm, a width of 12 mm, and a thickness of 0.70 mm for evaluation of withstand voltage. Furthermore, the plate-shaped compacts were dried at 150° C. for 2 hours to cure the thermosetting resin, thereby fabricating plate-shaped dust cores.

### [Method for Calculating Magnetic Permeability]

Inductance L of each of the ring-shaped dust cores at 0 A was measured using an LCR meter, and the magnetic permeability was calculated as initial magnetic permeability μi using the following equation (1) (at a measurement frequency of 100 kHz).

$$μ i = ( L \times le ) / ( μ0 \times Ae \times {n}^{2} ) \qquad ( 1 )$$

Note that le denotes the effective magnetic path length, μ0 denotes the magnetic permeability of the vacuum, Ae denotes the cross-sectional surface area, and n denotes the number of turns of the measurement coil.

### [Method for Calculating Magnetic Loss]

Magnetic loss was measured for each of the ring-shaped dust cores using a B-H analyzer under the conditions of Bm=25 mT and frequency=1 MHz. The higher the magnetic permeability and the insulation properties are, the smaller the magnetic loss becomes, and thus, the magnetic loss can be used as an indicator for evaluating the overall magnetic properties of the dust core. For example, reduction in magnetic loss indicates that high magnetic permeability and high insulation properties are both achieved.

### [Method for Evaluating Breakdown Voltage]

To measure breakdown voltage that serves as an index of insulation properties, each of the plate-shaped dust cores fabricated was sandwiched between conductive rubbers disposed on both main surfaces, a DC voltage at an initial value of 10 V was applied, and thereafter the value of the applied voltage was raised continuously at a rate of 5 V/min. The value of the applied voltage immediately before occurrence of breakdown was divided by the thickness of the compact, and the value (V/mm) obtained by the division was regarded as the value of breakdown voltage of the dust core. A higher value of breakdown voltage indicates higher insulation properties.

### [Method for Calculating Strength]

A load was applied to each of the fabricated plate-shaped dust cores at a speed of 0.5 mm/min in a 3-point bending test, and the load that was on the dust core when the dust core broke was used as the measurement value. Strength a (N/mm²) was calculated from the obtained measurement value using the following Equation (2).

$$σ = 3 \times Pb \times Ls / 1 {WT}^{2} \qquad ( 2 )$$

Note that Pb denotes the load (measurement value) that was on the dust core when the specimen broke, Ls denotes the distance between the fulcrums in millimeters (8 mm in this measurement), W denotes the width of the dust core, and T denotes the thickness of the dust core.

### [Elemental Analysis]

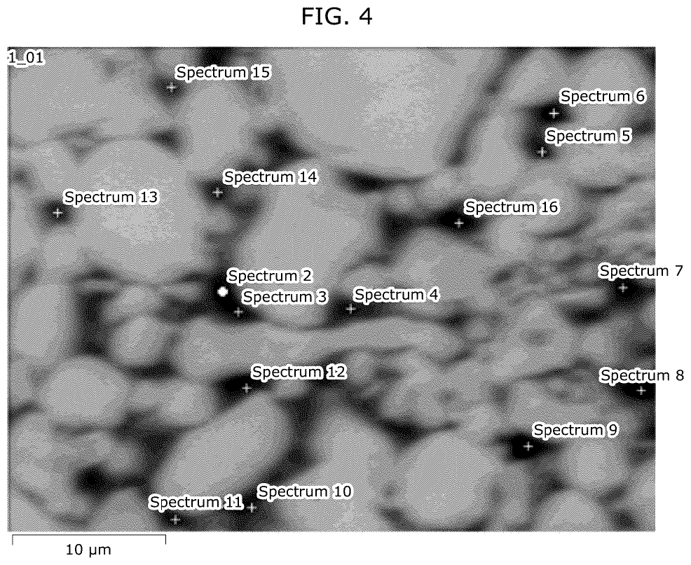

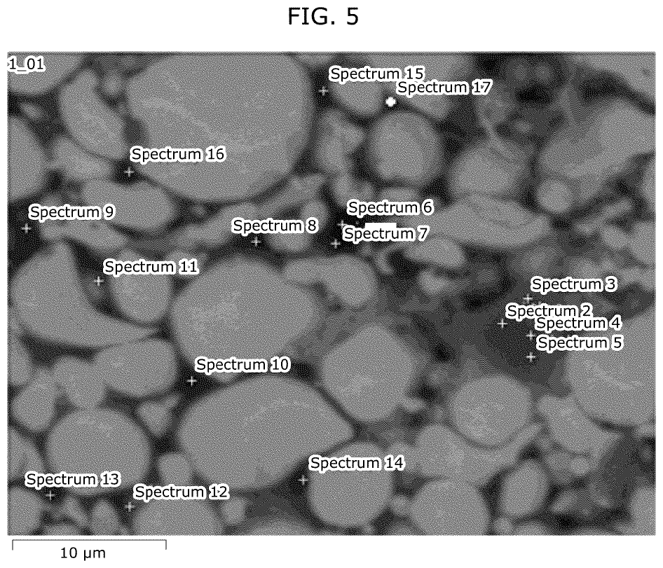

After each of the fabricated plate-shaped dust cores was embedded in resin and cut, the dust core was subjected to ion milling to form a cross section for observation, and elemental analysis of the dust core was performed based on the image of the cross section using SEM-EDX. Specifically, as the measurement points in the image of the cross section, 15 locations between the particles of the metal magnetic powder (i.e., locations where the binding agent is present) were selected in a manner that the locations are distributed in the entire image, and the Si element and the C element were detected on a weight basis from the EDX spectrum obtained at each measurement point. FIG. 4 is a diagram showing an image of a cross section of a dust core according to Working Example 1, and FIG. 5 is a diagram showing an image of a cross section of a dust core according to Comparative Example 1. FIG. 4 and FIG. 5 each show a SEM image of a cross section formed using the method described above. The magnification of the SEM images shown in FIG. 4 and FIG. 5 is 3000 times. The white crosses in the images in FIG. 4 and FIG. 5 are the measurement points. As shown in FIG. 4 and FIG. 5, the locations of 15 measurement points were determined to include measurement points between different particles of the metal magnetic powder. The size of the region to be measured at each measurement point was 1089 nm²=33 nm×33 nm. Dust cores other than the dust cores according to Working Example 1 and Comparative Example 1 were also subjected to elemental analysis in the same manner.

### [Results of Analysis and Evaluation]

First, with reference to Tables 1 to 3 and FIG. 4 and FIG. 5, the following describes the results of analysis and evaluation of dust cores that differ in the resins used as the binding agent.

Table 1 shows, for each of the dust cores according to Working Example 1 and Comparative Examples 1 to 3: the added amount and the viscosity of each of the silicone resin and the epoxy resin used as the binding agent; the weight proportion of the silicone resin in the binding agent; the elemental analysis result; the strength, the magnetic permeability; the magnetic loss; and the breakdown voltage.

TABLE 1

| | Binding agent | | | | | |
|---|---|---|---|---|---|---|
| | | | | | | Elemental |
| | Silicone resin | | Epoxy resin | | Weight | analysis result |
| | Added amount | | Added amount | | proportion | (Z = Si element |
| | [Parts by | Viscosity | [Parts by | Viscosity | of silicone | rate) |
| | weight] | [mPa · s] | weight] | [mPa · s] | resin | Max Z |
| Working | 1.25 | 180 | 1.25 | 400 | 0.5 | 0.290 |
| example 1 | | | | | | |
| Comparative | 1.25 | 180 | 1.25 | 15000 | 0.5 | 0.678 |
| example 1 | | | | | | |
| Comparative | 2.50 | 180 | 0 | — | 1.0 | — |
| example 2 | | | | | | |
| Comparative | 0 | — | 2.50 | 400 | 0 | — |
| example 3 | | | | | | |

| | Binding agent | | | | | |
|---|---|---|---|---|---|---|
| | Elemental analysis | | Dust core evaluation result | | | |
| | result | | Mechanicall | Magnetic properties | | |
| | (Z = Si element rate) | | property | Magnetic | Magnetic | Breakdown |
| | | Max Z − | Strength | permeability | loss | voltage |
| | Min Z | Min Z | [MPa] | μl | [kW/m³] | [V/mm] |
| Working | 0.219 | 0.071 | 34.3 | 25.0 | 821 | 253 |
| example 1 | | | | | | |
| Comparative | 0.056 | 0.622 | 42.3 | 23.2 | 1165 | 189 |
| example 1 | | | | | | |
| Comparative | — | — | 26.2 | 31.3 | 1121 | 121 |
| example 2 | | | | | | |
| Comparative | — | — | 40.3 | 16.3 | 1899 | 273 |
| example 3 | | | | | | |

As shown in Table 1, the dust core according to Working Example 1 includes, as the binding agent, a resin in which a silicone resin having a viscosity of 180 mPa·s and an epoxy resin having a viscosity of 400 mPa·s are mixed at the weight ratio of 1:1. The dust core according to Comparative Example 1 includes an epoxy resin having a viscosity of 15000 mPa·s in place of the epoxy resin having a viscosity of 400 mPa·s used in Working Example 1. The dust core according to Comparative Example 2 includes, as the binding agent, only the silicone resin used in Working Example 1. The dust core according to Comparative Example 3 includes, as the binding agent, only the epoxy resin used in Working Example 1.

The results of elemental analysis will now be described with reference to Tables 1 to 3 and FIG. 4 and FIG. 5. As the results of elemental analysis, Tables 2 and 3 show the amount of the Si element detected x, the amount of the C element detected y, and Z=x/(x+y). The amount of the Si element detected x shown in Tables 2 and 3 indicates the weight percentage (%) of the Si element relative to the sum of the weights of the Si element and the C element detected. The amount of the C element detected y shown in Tables 2 to 5 indicates the weight percentage (%) of the C element relative to the sum of the weights of the Si element and the C element detected.

FIG. 4 is an image of a cross section of the dust core according to Working Example 1. Table 2 shows the results of detection of the Si element and the C element on a weight basis at 15 measurement points based on the image of the cross section shown in FIG. 4.

TABLE 2

| Measurement | Si element x | C element y | |
|---|---|---|---|
| point | (%) | (%) | Z = x/(x + y) |
| 1 | 27.4 | 72.6 | 0.274 |
| 2 | 27.9 | 72.1 | 0.279 |
| 3 | 23.8 | 76.2 | 0.238 |
| 4 | 25.9 | 74.1 | 0.259 |
| 5 | 26.3 | 73.7 | 0.263 |
| 6 | 23.7 | 76.3 | 0.237 |
| 7 | 23.4 | 76.6 | 0.234 |
| 8 | 22.1 | 77.9 | 0.221 |
| 9 | 26.7 | 73.3 | 0.267 |
| 10 | 25.8 | 74.2 | 0.258 |
| 11 | 26.6 | 73.4 | 0.266 |
| 12 | 29.0 | 71.0 | 0.29 |
| 13 | 28.8 | 71.2 | 0.288 |
| 14 | 24.1 | 75.9 | 0.241 |
| 15 | 21.9 | 78.1 | 0.219 |
| Max | 29.0 | 78.1 | 0.29 |
| Min | 21.9 | 71.0 | 0.219 |
| Max − Min | 7.1 | 7.1 | 0.071 |

As shown in Table 2, in Working Example 1, the difference between the maximum value (Max) and the minimum value (Min) of Z=x/(x+y) values at the respective measurement points is 0.071. In the present specification, the maximum value may be denoted as “Max Z”, the minimum value may be denoted as “Min Z”, and the difference between the maximum value and the minimum value may be denoted as “Max Z-Min Z”.

FIG. 5 is an image of a cross section of the dust core according to Comparative Example 1. Table 3 shows the results of detection of the Si element and the C element on a weight basis at 15 measurement points based on the image of the cross section shown in FIG. 5.

TABLE 3

| Measurement | Si element x | C element y | |
|---|---|---|---|
| point | (%) | (%) | Z = x/(x + y) |
| 1 | 65.6 | 34.4 | 0.656 |
| 2 | 64.6 | 35.4 | 0.646 |
| 3 | 67.8 | 32.2 | 0.678 |
| 4 | 65.9 | 34.1 | 0.659 |
| 5 | 6.5 | 93.5 | 0.065 |
| 6 | 10.2 | 89.8 | 0.102 |
| 7 | 12.5 | 87.5 | 0.125 |
| 8 | 5.6 | 94.4 | 0.056 |
| 9 | 7.5 | 92.5 | 0.075 |
| 10 | 10.7 | 89.3 | 0.107 |
| 11 | 10.9 | 89.1 | 0.109 |
| 12 | 10.9 | 89.1 | 0.109 |
| 13 | 19.6 | 80.4 | 0.196 |
| 14 | 11.3 | 88.7 | 0.113 |
| 15 | 13.1 | 86.9 | 0.131 |
| Max | 67.8 | 94.4 | 0.678 |
| Min | 5.6 | 32.2 | 0.056 |
| Max − Min | 62.2 | 62.2 | 0.622 |

As shown in Table 3, “MaxZ-MinZ” is 0.622 in Comparative Example 1. Therefore, the dust core according to Working Example 1 has smaller variation in the weight proportion of the Si element than the dust core according to Comparative Example 1. That is to say, the silicone resin is more evenly dispersed. The silicone resin is considered to have evenly dispersed because the epoxy resin used in Working Example 1 is lower in viscosity than the epoxy resin used in Comparative Example 1. In contrast, with the dust core according to Comparative Example 1, the silicone resin is unevenly distributed in the binding agent. There is a possibility that the Si element is unevenly distributed even within the silicone resin.

Next, with reference to Table 1 again, the evaluation results of the dust cores according to Working Example 1 and Comparative Examples 1 to 3 will be described. The magnetic loss of the dust core according to Working Example 1, which includes a mixture of the silicone resin and the epoxy resin as the binding agent, is less than the magnetic loss of the dust cores according to Comparative Examples 2 and 3, which include only the silicone resin or the epoxy resin as the binding agent.

Since the dust core according to Working Example 1 includes a relatively soft silicone resin, the distance between the particles of the metal magnetic powder is reduced, allowing an increase in the magnetic permeability. In addition, despite the reduced distance, since the silicone resin and the epoxy resin are evenly distributed, contact between the particles is inhibited by the presence of the relatively hard epoxy resin, and the dust core evenly holds insulation properties in its entirety. It is therefore considered that, with the dust core according to Working Example 1, high magnetic permeability and high insulation properties are both achieved and the magnetic loss is less than that of the dust cores according to Comparative Examples 2 and 3.

Even in the case of mixing a silicone resin and an epoxy resin, if the silicone resin is unevenly distributed due to a high viscosity of the epoxy resin as in Comparative Example 1, it is considered that contact between the particles of the metal magnetic powder cannot be easily inhibited in some locations and the insulation properties are thus not held but are degraded. This is considered to be the reason why the magnetic loss did not decrease.

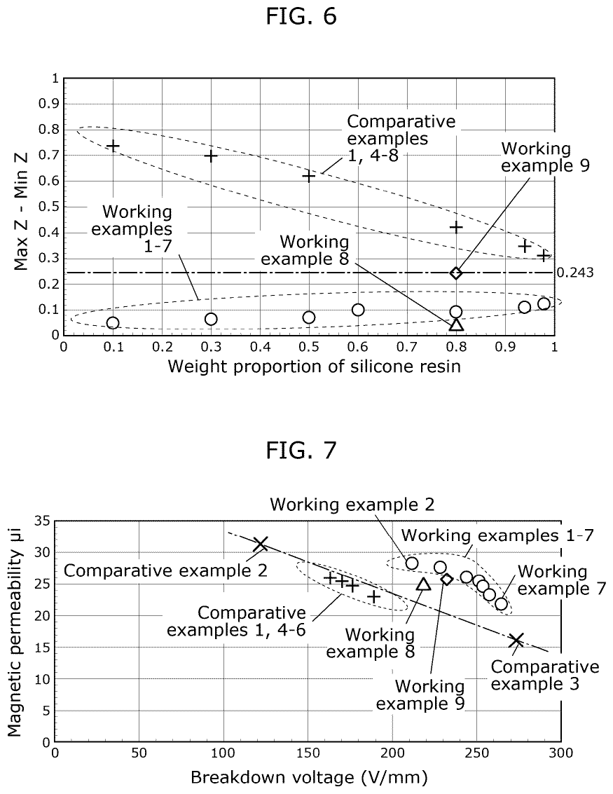

Next, with reference to Table 4 and FIG. 6 and FIG. 7, the following describes the results of analysis and evaluation of dust cores that differ in the weight ratio between the silicone resin and the epoxy resin that are used as the binding agent and in the viscosities of the resins.

Table 4 shows, for each of dust cores according to Working Examples 1 to 9 and Comparative Examples 1 to 8: the added amount and the viscosity of each of the silicone resin and the epoxy resin used as the binding agent; the weight proportion of the silicone resin in the binding agent; the elemental analysis result; the strength; the magnetic permeability; the magnetic loss; and the breakdown voltage. Note that the evaluation of the dust core properties was not performed for the dust cores according to Comparative Examples 7 and 8. FIG. 6 is a diagram showing relationships between the weight proportion of the silicone resin and “Max Z-Min Z” of each of the dust cores according to the working examples and the comparative examples shown in Table 4. FIG. 7 is a diagram showing relationships between the breakdown voltage and the magnetic permeability of the dust cores according to the working examples and the comparative examples shown in Table 4.

TABLE 4

| | Binding agent | | | | | |
|---|---|---|---|---|---|---|
| | | | | | | Elemental analysis |
| | Silicone resin | | Epoxy resin | | Weight | result |
| | Added amount | | Added amount | | proportion | (Z = Si element |
| | [Parts by | Viscosity | [Parts by | Viscosity | of silicone | rate) |
| | weight] | [mPa · s] | weight] | [mPa · s] | resin | Max Z |
| Working example 2 | 2.45 | 180 | 0.05 | 400 | 0.98 | 0.193 |
| Working example 3 | 2.35 | 180 | 0.15 | 400 | 0.94 | 0.263 |
| Working example 4 | 2.00 | 180 | 0.50 | 400 | 0.80 | 0.227 |
| Working example 5 | 1.50 | 180 | 1.00 | 400 | 0.60 | 0.184 |
| Working example 1 | 1.25 | 180 | 1.25 | 400 | 0.50 | 0.290 |
| Working example 6 | 0.75 | 180 | 1.75 | 400 | 0.30 | 0.080 |
| Working example 7 | 0.25 | 180 | 2.25 | 400 | 0.10 | 0.061 |
| Working example 8 | 2.00 | 500 | 0.50 | 1000 | 0.80 | 0.179 |
| Working example 9 | 2.00 | 500 | 0.50 | 1500 | 0.80 | 0.270 |
| Comparative example 4 | 2.45 | 180 | 0.05 | 15000 | 0.98 | 0.332 |
| Comparative example 5 | 2.35 | 180 | 0.15 | 15000 | 0.94 | 0.379 |
| Comparative example 6 | 2.00 | 180 | 0.50 | 15000 | 0.80 | 0.428 |
| Comparative example 1 | 1.25 | 180 | 1.25 | 15000 | 0.50 | 0.678 |
| Comparative example 7 | 0.75 | 180 | 1.75 | 15000 | 0.30 | 0.724 |
| Comparative example 8 | 0.25 | 180 | 2.25 | 15000 | 0.10 | 0.762 |
| Comparative example 2 | 2.50 | 180 | 0 | — | 1.00 | — |
| Comparative example 3 | 0 | — | 2.50 | 400 | 0 | — |

| | Binding agent | | Dust core evaluation result | | | |
|---|---|---|---|---|---|---|
| | Elemental analysis result | | Mechanical | Magnetic properties | | |
| | (Z = Si element rate) | | property | Magnetic | Magnetic | Breakdown |
| | | Max Z − | Strength | permeability | loss | voltage |
| | Min Z | Min Z | [MPa] | μl | [kW/m³] | [V/mm] |
| Working example 2 | 0.069 | 0.124 | 31.1 | 28.4 | 903 | 211 |
| Working example 3 | 0.153 | 0.110 | 30.1 | 27.8 | 805 | 228 |
| Working example 4 | 0.134 | 0.093 | 32.5 | 26.2 | 855 | 244 |
| Working example 5 | 0.085 | 0.099 | 33.9 | 25.6 | 908 | 251 |
| Working example 1 | 0.219 | 0.071 | 34.3 | 25.0 | 821 | 253 |
| Working example 6 | 0.015 | 0.065 | 35.8 | 23.6 | 811 | 257 |
| Working example 7 | 0.013 | 0.048 | 37.0 | 22.1 | 819 | 264 |
| Working example 8 | 0.131 | 0.048 | 35.5 | 25.8 | 910 | 232 |
| Working example 9 | 0.027 | 0.243 | 36.8 | 25.2 | 960 | 218 |
| Comparative example 4 | 0.016 | 0.316 | 32.8 | 26.0 | 1201 | 163 |
| Comparative example 5 | 0.027 | 0.352 | 33.5 | 25.6 | 1187 | 170 |
| Comparative example 6 | 0.004 | 0.424 | 34.8 | 24.9 | 1087 | 176 |
| Comparative example 1 | 0.056 | 0.622 | 42.3 | 23.2 | 1165 | 189 |
| Comparative example 7 | 0.026 | 0.698 | — | — | — | — |
| Comparative example 8 | 0.024 | 0.738 | — | — | — | — |
| Comparative example 2 | — | — | 26.2 | 31.3 | 1121 | 121 |
| Comparative example 3 | — | — | 40.3 | 16.3 | 1899 | 273 |

As shown in Table 4, the dust cores according to Working Examples 1 to 7 were fabricated using, as the binding agent, a silicone resin having a viscosity of 180 mPa·s and an epoxy resin having a viscosity of 400 mPa·s, at the weight proportions of the silicone resin shown in Table 4. The dust core according to Working Example 8 was fabricated using, as the binding agent, a silicone resin having a viscosity of 500 mPa·s and an epoxy resin having a viscosity of 1000 mPa·s, at the weight proportion of the silicone resin shown in Table 4. The dust core according to Working Example 9 was fabricated using, as the binding agent, a silicone resin having a viscosity of 500 mPa·s and an epoxy resin having a viscosity of 1500 mPa·s, at the weight proportion of the silicone resin shown in Table 4. The dust core according to Comparative Examples 1 and 4 to 8 were fabricated using, as the binding agent, a silicone resin having a viscosity of 180 mPa·s and an epoxy resin having a viscosity of 15000 mPa·s, at the weight proportions of the silicone resin shown in Table 4. The dust cores according to Comparative Examples 2 and 3 are as described above.

As shown in Table 4 and FIG. 6, the dust cores according to Working Examples 1 to 9 including an epoxy resin having relatively low viscosity have small “MaxZ-MinZ” as compared to the dust cores according to Comparative Examples 1 and 4 to 8 including an epoxy resin having relatively high viscosity. Specifically, “Max Z-Min Z” of each of the dust cores according to Working Examples 1 to 9 is at most 0.243. That is to say, it can be said that the silicone resin of each of the dust cores according to Working Examples 1 to 9 is evenly dispersed in the binding agent as compared to the silicone resin of each of the dust cores according to Comparative Examples 1 and 4 to 8. In particular, use of an epoxy resin having a viscosity of 1000 mPa·s can make “MaxZ-MinZ” smaller. As shown above, lowering the viscosity of the epoxy resin used as the binding agent can lead to greater dispersion of the silicone resin in the binding agent.

With the dust cores according to Comparative Examples 1 and 4 to 8, the smaller the weight proportion of the silicone resin is, the larger the “MaxZ-MinZ” becomes, and the more susceptible the silicone resin becomes to uneven distribution in the binding agent. In contrast, with the dust cores according to Working Examples 1 to 7, there was no tendency of “MaxZ-MinZ” to increase even when the weight proportion of the silicone resin decreased.

As shown in Table 4, the magnetic loss of each of the dust cores according to Working Examples 1 to 9 is less than the magnetic loss of each of the dust cores according to Comparative Examples 1 to 6. That is to say, use of the epoxy resin having relatively low viscosity as the binding agent allows the silicone resin to evenly disperse regardless of the weight proportion of the silicone resin, thus enabling reduction in the magnetic loss. Moreover, the strength of each of the dust cores according to Working Examples 1 to 9 is greater than the strength of the dust core according to Comparative Example 2; the dust core strength is improved by adding the epoxy resin.

The reason for the reduction in the magnetic loss is considered to be that the magnetic permeability and the insulation properties of the dust core became higher than the magnetic permeability and the insulation properties of the dust core in the trade-off relationship. As shown in FIG. 7, changing the binding agent from only the silicone resin to only the epoxy resin increases the breakdown voltage but decreases the magnetic permeability as seen in the relationship between Comparative Examples 2 and 3. The relationships between the magnetic permeability and the breakdown voltage of the dust cores according to Comparative Examples 1 and 4 to 6 are approximately plotted in the vicinity of a straight line passing through the plot of Comparative Example 2 and the plot of Comparative Example 3 (the single-dotted line in FIG. 7). This is considered to be due to the uneven distribution of the silicone resin. In contrast, the relationships between the magnetic permeability and the breakdown voltage of the dust cores according to Working Examples 1 to 9 are plotted in a region where the magnetic permeability and the breakdown voltage are higher than the magnetic permeability and the breakdown voltage indicated by the straight line passing through the plot of Comparative Example 2 and the plot of Comparative Example 3. That is to say, the magnetic permeability and the insulation properties of the dust cores according to Working Examples 1 to 9 are higher than the magnetic permeability and the insulation properties of the dust cores in the trade-off relationship exemplified by the comparative examples. This is considered to be the reason why the magnetic loss of the dust cores according to Working Examples 1 to 9 has decreased.

Dust cores whose weight proportions of the silicone resin are greater than 0.98 and less than 1 are considered to have a relationship of the magnetic permeability and the insulation properties between the plot of Working Example 2 and the plot of Comparative Example 2 in FIG. 7. Dust cores whose weight proportions of the silicone resin are greater than 0 and less than 0.1 are considered to have a relationship of the magnetic permeability and the insulation properties between the plot of Working Example 7 and the plot of Comparative Example 3 in FIG. 7. Therefore, even when the weight proportion of the silicone resin is greater than 0.98 and less than 1 and when the weight proportion of the silicone resin is greater than 0 and less than 0.1, it is considered that the magnetic permeability and the insulation properties can be higher than the magnetic permeability and the insulation properties indicated by the line of the trade-off relationship between the magnetic permeability and the insulation properties of the dust cores according to comparative examples.

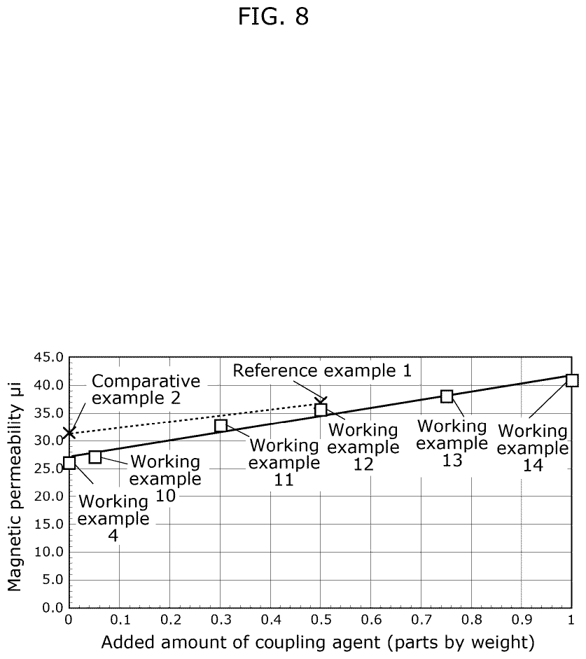

Next, with reference to Table 5 and FIG. 8, the following describes the results of analysis and evaluation of dust cores to which a coupling agent has been further added.

Table 5 shows, for each of the dust cores according to Working Examples 4 and 10 to 16, Comparative Example 2, and Reference Example 1: the type and added amount of the coupling agent used; the added amount and viscosity of each of the silicone resin and the epoxy resin used as the binding agent; the weight proportion of the silicone resin in the binding agent; the strength; the magnetic permeability; the magnetic loss; and the breakdown voltage. FIG. 8 is a diagram showing relationships between the added amount of the coupling agent and the magnetic permeability of the dust cores according to the working examples, the comparative example, and the reference example shown in Table 5.

TABLE 5

| | | | Binding agent | | | |
|---|---|---|---|---|---|---|
| | Coupling agent | | Silicone resin | | Epoxy resin | |
| | | Added amount | Added amount | | Added amount | |
| | | [Parts by | [Parts by | Viscosity | [Parts by | Viscosity |
| | Type | weight] | weight] | [mPa · s] | weight] | [mPa · s] |
| Working example 4 | — | 0 | 2.0 | 180 | 0.5 | 400 |
| Working example 10 | Titanate | 0.05 | 2.0 | 180 | 0.5 | 400 |
| Working example 11 | Titanate | 0.30 | 2.0 | 180 | 0.5 | 400 |
| Working example 12 | Titanate | 0.50 | 2.0 | 180 | 0.5 | 400 |
| Working example 13 | Titanate | 0.75 | 2.0 | 180 | 0.5 | 400 |
| Working example 14 | Titanate | 1.00 | 2.0 | 180 | 0.5 | 400 |
| Working example 15 | Mercapto | 0.05 | 2.0 | 180 | 0.5 | 400 |
| Working example 16 | Mercapto | 0.30 | 2.0 | 180 | 0.5 | 400 |
| Comparative example 2 | — | 0 | 2.5 | 180 | 0 | — |
| Reference example 1 | Titanate | 0.50 | 2.5 | 180 | 0 | — |

| | Binding agent | Dust core evaluation result | | | |
|---|---|---|---|---|---|
| | Weight | Mechanical | Magnetic properties | | |
| | proportion | property | Magnetic | Magnetic | Breakdown |
| | of silicone | Strength | permeability | loss | voltage |
| | resin | [MPa] | μl | [kW/m³] | [V/mm] |
| Working example 4 | 0.8 | 32.5 | 26.2 | 855 | 244 |
| Working example 10 | 0.8 | 32.9 | 27.2 | 832 | 247 |
| Working example 11 | 0.8 | 32.4 | 32.8 | 803 | 245 |
| Working example 12 | 0.8 | 32.5 | 35.8 | 800 | 246 |
| Working example 13 | 0.8 | 30.3 | 38.2 | 804 | 238 |
| Working example 14 | 0.8 | 29.0 | 41.0 | 799 | 221 |
| Working example 15 | 0.8 | 31.1 | 26.4 | 860 | 231 |
| Working example 16 | 0.8 | 30.0 | 26.9 | 848 | 226 |
| Comparative example 2 | 1.0 | 26.2 | 31.3 | 1121 | 121 |
| Reference example 1 | 1.0 | 23.0 | 36.8 | 900 | 125 |

As shown in Table 5, the dust cores according to Working Examples 10 to 14 were fabricated using a mixture of the materials of the dust core according to Working Example 4 and a titanate-based coupling agent further added in the amounts shown in Table 5. The dust cores according to Working Examples 15 and 16 were fabricated using a mixture of the materials of the dust core according to Working Example 4 and a mercapto-based coupling agent further added in the amounts shown in Table 5. The dust core of Reference Example 1 was fabricated using a mixture of the material of the dust core according to Comparative Example 2 and a titanate-based coupling agent further added in the amount shown in Table 5.

As shown in Table 5 and FIG. 8, the magnetic permeability of the dust cores according to Working Examples 10 to 14 in which the titanate-based coupling agent was added increased as compared to the dust core according to Working Example 4 in which the titanate-based coupling agent was not added. As the magnetic permeability increased, the magnetic loss of the dust cores according to Working Examples 10 to 14 in which the titanate-based coupling agent was added decreased as compared to the dust core according to Working Example 4 in which the titanate-based coupling agent was not added.

The magnetic permeability of the dust cores according to Comparative Example 2 and Reference Example 1 in which only the silicone resin was included as the binding agent also increased as a result of the addition of the titanate-based coupling agent. However, as compared to the results of the dust cores according to Working Examples 4 and 10 to 14 in which the silicone resin and the epoxy resin were included as the binding agent, the increase in the magnetic permeability was small. Specifically, when a comparison is made between Working Example 12 and Reference Example 1 in which the same amount of titanate-based coupling agent was added, the magnetic permeability increased by 9.6 in Working Example 12 whereas the magnetic permeability increased only by 5.5 in Reference Example 1, as compared to the case where the titanate-based coupling agent was not added. As shown in FIG. 8, the slope of increase in the magnetic permeability of the dust cores according to Working Examples 4 and 10 to 14 (the solid approximate line) in the case of changing the added amount of the titanate-based coupling agent is greater than the slope of increase in the magnetic permeability of the dust cores according to Working Example 12 and Reference Example 1 (the dotted approximate line).

The coupling agent is a material for enhancing the binding of resin (the binding agent) and the magnetic metal powder, and is considered to reduce the distance between the particles of the metal magnetic powder through the binding agent, thereby increasing the magnetic permeability. It is presumed that, in the case of using a binding agent that includes a silicone resin and an epoxy resin, the coupling agent has an impact also on, for example, the dispersion and morphology of the silicone resin and the epoxy resin and the effect of reducing the distance between the particles of the metal magnetic powder is prominent, thereby further increasing the magnetic permeability. Note that the elemental analysis of the dust core according to Working Example 14 in which one weight part of the titanate-based coupling agent was added, shows that “MaxZ-MinZ” was 0.097, that is, there was no change from the case of not adding the titanate-based coupling agent. Therefore, there is a possibility that the addition of the titanate-based coupling agent has changed the state of the presence of the silicone resin in a more microscopic point of view.

The magnetic permeability of the dust cores according to Working Examples 15 and 16 in which the mercapto-based coupling agent was added increased slightly as compared to the dust core according to Working Example 4 in which the mercapto-based coupling agent was not added.

### [Conclusion]

The results of analysis and evaluation of the above working examples and comparative examples showed that, with a dust core that includes a binding agent containing a silicone resin and an epoxy resin and whose “MaxZ-MinZ” is at most 0.243 in the elemental analysis based on an image of a cross section of the dust core, it is possible to achieve both high magnetic permeability and high insulation properties, thereby enabling reduction in the magnetic loss. Specifically, including a silicone resin having a viscosity of at most 500 mPa·s and an epoxy resin having a viscosity of at most 1500 mPa·s allowed the dust core to have “MaxZ-MinZ” of at most 0.243.

In contrast, even with the dust core including a binding agent containing a silicone resin and an epoxy resin, it was not possible, when “MaxZ-MinZ” increased due to a high viscosity of the epoxy resin, to make the magnetic permeability and the insulation properties higher than the magnetic permeability and the insulation properties in the trade-off relationship, and it was thus not possible to reduce the magnetic loss.

The results of analysis and evaluation also showed that further adding the titanate-based coupling agent to the materials of the dust core further increased the magnetic permeability, and it was therefore possible to further reduce the magnetic loss.

### Other Embodiments Etc

Although the dust core and so on according to an embodiment of the present disclosure, for example, have been described above, the present disclosure is not limited to this embodiment.

In the above embodiment, the Si element and the C element were detected at 15 measurement points in the image, but the total number of measurement points is not limited to 15. For example, the total number of measurement points may be N, where N is an integer greater than or equal to 10, for example.

For example, electrical components that include the dust core described above are also included in the present disclosure. Examples of the electrical components include inductance components such as high-frequency reactors, inductors, and transformers. Power supply devices that include the electrical components described above are also included in the present disclosure.

The present disclosure is not limited to the above embodiment. Various modifications to the present embodiment that may be conceived by those skilled in the art, as well as forms resulting from combinations of constituent elements from different embodiments may be included within the scope of one or more aspects, so long as such modifications and forms do not depart from the essence of the present disclosure.

The following are examples of the dust core and the method for manufacturing the dust core that have been described based on the above embodiment.

A dust core according to a first aspect of the present disclosure is a dust core including: a metal magnetic powder; and a binding agent that binds particles of the metal magnetic powder, wherein the binding agent includes a silicone resin and an epoxy resin, and in an elemental analysis of the dust core based on an image of a cross section of the dust core, when a silicon (Si) element and a carbon (C) element are detected on a weight basis at 15 measurement points between the particles of the metal magnetic powder in the image, a difference between a maximum value and a minimum value of x/(x+y) values at the 15 measurement points is at most 0.243, where x denotes an amount of the Si element detected and y denotes an amount of the C element detected.

For example, a dust core according a second aspect of the present disclosure is the dust core according to the first aspect, wherein a weight of the silicone resin is at least 10% and at most 98% of a sum of the weight of the silicone resin and a weight of the epoxy resin.

For example, a dust core according a third aspect of the present disclosure is the dust core according to the first aspect or the second aspect, and further includes a titanate-based coupling agent.

A method for manufacturing a dust core according to a fourth aspect of the present disclosure is a method for manufacturing the dust core according to any one of the first to the third aspects, and includes: mixing the metal magnetic powder, the silicone resin, and the epoxy resin to generate a mixture including the metal magnetic powder and the binding agent; and pressure-molding the mixture generated, wherein in the mixing, the epoxy resin to be mixed has a viscosity of at most 1500 mPa·s at 23° C.

For example, a method for manufacturing a dust core according to a fifth aspect of the present disclosure is the method according to the fourth aspect, wherein in the mixing, the silicone resin to be mixed has a viscosity of at most 500 mPa·s at 25° C.

For example, a method for manufacturing a dust core according to a sixth aspect of the present disclosure is the method according to the fourth aspect or the fifth aspect, wherein in the mixing, a titanate-based coupling agent is further mixed in to generate the mixture.

A method for manufacturing a dust core according to a seventh aspect of the present disclosure includes: mixing a metal magnetic powder, a silicone resin, and an epoxy resin to generate a mixture; and pressure-molding the mixture generated, wherein in the mixing, the silicone resin to be mixed has a viscosity of at most 500 mPa·s at 25° C. and the epoxy resin to be mixed has a viscosity of at most 1500 mPa·s at 23° C.

For example, a method for manufacturing a dust core according to an eighth aspect of the present disclosure is the method according to the seventh aspect, wherein in the mixing, a titanate-based coupling agent is further mixed in to generate the mixture.

### INDUSTRIAL APPLICABILITY

The dust core according to the present disclosure can be used as a material and the like of the magnetic core of a high frequency inductor or a transformer.

### REFERENCE SIGNS LIST

10 dust core
11 metal magnetic powder
12 binding agent
20, 30 lead portion
25 first terminal member
35 second terminal member
40 coil member
100 electrical component

1. A dust core comprising:
a metal magnetic powder; and
a binding agent that binds particles of the metal magnetic powder,
wherein the binding agent includes a silicone resin and an epoxy resin, and in an elemental analysis of the dust core based on an image of a cross section of the dust core,
when a silicon (Si) element and a carbon (C) element are detected on a weight basis at 15 measurement points between the particles of the metal magnetic powder in the image,
a difference between a maximum value and a minimum value of x/(x+y) values at the 15 measurement points is at most 0.243, where x denotes an amount of the Si element detected and y denotes an amount of the C element detected.

2. The dust core according to claim 1,
wherein a weight of the silicone resin is at least 10% and at most 98% of a sum of the weight of the silicone resin and a weight of the epoxy resin.

3. The dust core according to claim 1, further comprising:
a titanate-based coupling agent.

4. A method for manufacturing the dust core according to claim 1, the method comprising:
mixing the metal magnetic powder, the silicone resin, and the epoxy resin to generate a mixture including the metal magnetic powder and the binding agent; and
pressure-molding the mixture generated,
wherein in the mixing, the epoxy resin to be mixed has a viscosity of at most 1500 mPa·s at 23° C.

5. The method according to claim 4,
wherein in the mixing, the silicone resin to be mixed has a viscosity of at most 500 mPa·s at 25° C.

6. The method according to claim 4,
wherein in the mixing, a titanate-based coupling agent is further mixed in to generate the mixture.

7. A method for manufacturing a dust core, the method comprising:
mixing a metal magnetic powder, a silicone resin, and an epoxy resin to generate a mixture; and
pressure-molding the mixture generated,
wherein in the mixing, the silicone resin to be mixed has a viscosity of at most 500 mPa·s at 25° C. and the epoxy resin to be mixed has a viscosity of at most 1500 mPa·s at 23° C.

8. The method according to claim 7,
wherein in the mixing, a titanate-based coupling agent is further mixed in to generate the mixture.
